(19) United States
(12) Patent Application Publication
(10) Pub. No.: US 2026/0036949 A1
(43) Pub. Date: Feb. 5, 2026

(54) METHOD FOR ADJUSTING CORRECTION VALUES FOR USE IN METERING FUEL

(71) Applicant: Robert Bosch GmbH, Stuttgart (DE)

(72) Inventors: Tilo Starkert, Neidlingen (DE); Bhavish Kallare, Bejai (IN); Daniel Heitz, Rutesheim (DE); Kilian Bucher, Waldenbuch (DE); Martin Klander, Weinstadt (DE); Nico Knoedler, Untergruppenbach (DE); Selvaraj Suresh, Coimbatore (IN)

(21) Appl. No.: 19/277,828

(22) Filed: Jul. 23, 2025

(30) Foreign Application Priority Data
Jul. 30, 2024 (DE) 10 2024 207 187.0

(51) Int. Cl. G05B 13/02

(52) U.S. Cl. CPC G05B 13/0265

(57) ABSTRACT

A method for adjusting correction values for metering fuel using at least one fuel injector, from a high-pressure accumulator into a combustion chamber of an internal combustion engine, using training and correction datasets. The method includes: in the correction dataset, adjusting the correction values based on training values of the training dataset, the correction value in each active neighboring field being adjusted based on a mean neighboring field training value, the correction value in each field of each field region that includes an active field being adjusted based on a mean field training value, wherein the correction value in each inactive field is adjusted based on a transfer training value, the transfer training value being determined according to at least one correlation rule, based on the training values of the active neighboring fields; and providing the correction map having the adjusted correction values for further use.

### FIELD

The present invention relates to a method for adjusting correction values for use in metering fuel, by means of at least one fuel injector, from a high-pressure accumulator into a combustion chamber of an internal combustion engine, and to a computing unit and a computer program for carrying out the method.

### BACKGROUND INFORMATION

For clean, i.e., as low-emission as possible, operation of internal combustion engines such as diesel engines, the metering of fuel into the combustion chambers of the internal combustion engine should always remain as accurate as possible over time or throughout its service life.

### SUMMARY

According to the present invention, a method for adjusting correction values as well as a computing unit and a computer program for carrying out the method are provided. Advantageous example embodiments of the present invention are disclosed herein.

The present invention relates to internal combustion engines, such as diesel engines, and the clean operation thereof. In particular, internal combustion engines with a high-pressure accumulator come into consideration, in which the fuel from the high-pressure accumulator is fed into the combustion chambers or cylinders by means of fuel injectors. These systems are also referred to as common rail injection systems. The accuracy of the fuel supply, i.e., of the quantity of fuel to be metered, should remain within certain limits throughout the entire service life in order to meet customer and legal requirements, for example.

In general, a desired value, the target quantity, can be specified for a quantity of fuel to be metered by means of a fuel injector in a feeding or injection process. The fuel injector can then be controlled accordingly to meter this target quantity. However, the quantity actually metered or fed, the actual quantity, may differ from the target quantity. Reasons for this could, for example, be the so-called sample variation, i.e., small deviations between different fuel injectors, or even age-related changes. The target quantity can therefore be corrected based on a correction value.

However, the deviation between the actual quantity and the target quantity can change over time, i.e., a correction value should also be adjusted over time.

For this purpose, so-called virtual sensors can be used, which detect (or estimate or calculate) the actual flow rate or flow quantity (through the fuel injectors) in order to be able to make a correction. Direct measurement is usually not possible or too complex. Such virtual sensors can use a fuel pressure in the high-pressure accumulator (the so-called rail pressure signal) which is detected by means of a sensor in order to calculate the corresponding value. A calculated actual quantity of fuel to be metered that would result in a certain target quantity can thus be determined.

The calculation may, for example, be based on trained data models or physical cause-effect relationships, e.g., on machine learning models. The correction value can be ascertained, for example, by comparing the calculated actual quantity with the target quantity for the current operating point. The correction value is typically filtered by a factor in order to reduce sensor noise. Such a correction value filtered by a factor can then be a so-called training value.

Against this background, an improved possibility of adjusting correction values for use in metering fuel is provided according to the present invention. For this purpose, a training dataset and a correction dataset are used.

According to an example embodiment of the present invention, the training dataset and the correction dataset each comprise a mutually corresponding plurality of fields (i.e., data fields), wherein each of the plurality of fields is assigned, for example, to a pressure of fuel in the high-pressure accumulator and to a quantity of fuel to be metered, i.e., to an operating point. Instead of specific pressure values, pressure ranges can also be used and, instead of specific quantities, quantity ranges can also be used. However, a different assignment can also be made, e.g., if fuel properties are to be calculated on the basis of the rail pressure.

According to an example embodiment of the present invention, the training dataset comprises one or more field regions, wherein the one or each of the plurality of field regions comprises one or more, in particular contiguous, fields of the plurality of fields. However, each of the plurality of fields is assigned to a field region, namely, in particular to exactly one field region. In other words, a field region can thus correspond to one field, but two or more fields can also be combined to form a field region; such combined fields can then be considered together, as explained below.

According to an example embodiment of the present invention, in the training dataset, a training value and a status are assigned to each of the plurality of fields and, in the correction dataset, a correction value is assigned to each of the plurality of fields. Below, the term “training map” is also used for the term “training dataset,” and the term “correction map” is also used for the term “correction dataset.” These are somewhat more descriptive terms; a map can, for example, be represented visually with the fields in a matrix-like manner. Ultimately, however, the training dataset and the correction map each represent a dataset with corresponding values. This also applies to other types of maps, which are mentioned below.

The status of each of the plurality of fields of the training map is a status from a status list, wherein the status list comprises at least the following statuses: active field, active neighboring field, inactive field, and, in particular, inactive field in a field region. However, even more statuses may also be provided.

An active field is a field in which the training value is such that an adjustment must be made. In one example embodiment of the present invention, it is provided that, if one or one of a plurality of specified activation criteria is present, the status of a field is changed to active field. Such an activation criterion could, for example, be that a number of learning events (in general, i.e., for all fields together) is higher than a specified threshold value. It is also possible that, for example, a number of learning events for an individual field is higher than a specified threshold value. Or, for example, that a period of time or driving distance for an individual field in relation to a comparison time point or a comparison distance is greater than a specified threshold value. For example, it may be provided that an adjustment should be made every two months, or every 1000 km. It is also possible that a number of working cycles of the internal combustion engine is counted and, if this number exceeds a threshold value, an activation criterion is considered to be present.

The virtual sensor can continuously provide calculated values (correction values). However, due to various boundary conditions, the virtual sensor is usually only valid (or trained) for certain or defined ranges and boundary conditions and is sufficiently accurate there. As mentioned, criteria for the validity of training values can be used (so-called learning releases). If all relevant criteria or learning releases are met, the training value can be written into the relevant field. This can then be regarded as a learning event.

In one example embodiment of the present invention, it is provided that, if one or one of a plurality of specified deactivation criteria is present, the status of a field is changed to inactive field. This can, for example, be after a specified period of time or driving distance in which no learning event has occurred for the relevant field since the change to active field.

An active neighboring field is a field that borders a field region in which an active field is present. When a field becomes an active field, it can also be provided at the same time that the status of active neighboring field applies to fields adjacent to the field region that comprises an active field. For example, if a field is set to active, relevant neighboring fields become active neighboring fields if they are not already. If a field is set to inactive, the neighboring fields can become an inactive field if they are not also neighboring fields of other active fields or, if applicable, of a field region or if correlation rules apply as described below.

An inactive field is a field that is not active and that is not an active neighboring field and that, in particular, is also not part of a field region which contains one or more active fields.

An inactive field in a field region is then a field in a field region that is not active.

Based on the training values in the training map, the correction values in the correction map are then adjusted. This is carried out depending on the particular status of the training values;

in this respect, the status only serves to decide how the training values are used.

According to an example embodiment of the present invention, the correction value in each of the active neighboring fields is adjusted based on a mean neighboring field training value. The mean neighboring field training value is determined based on the training value of the one or the training values of the plurality of active neighboring fields. It may, for example, be an arithmetic mean. If there is only one neighboring field, the mean neighboring field training value corresponds to the neighboring field training value.

The correction value in each field of each field region that comprises an active field (or possibly a plurality of active fields) is adjusted based on a mean field training value. The mean field training value is determined based on the training values of the active fields of the field region. It may, for example, be an arithmetic mean. If there is only one active field in the field region, the mean field training value corresponds to the field training value. In particular, the correction values of the fields that are inactive fields in the field region are also adjusted in this manner.

The correction value in each inactive field is adjusted based on a transfer training value. The transfer training value is determined according to at least one correlation rule, based on the training values of the active neighboring fields. This can, for example, be a correlation rule that applies to new parts or a correlation rule that applies to parts that have reached the end of their service life. The correlation rules can also be calibratable. For example, depending on the performance of the internal combustion engine, a value can be determined from or according to both correlation rules.

It is possible that, before the correction values are adjusted, the training values are transferred into an adjustment map (which also comprises the plurality of fields) according to the above rules. In each field, the correction value can then be adjusted based on the training values in the adjustment map.

That is to say, with the procedure according to an example embodiment of the present invention, not just one or a few correction values are adjusted, but many. In particular, correction values of which operating points are rarely or never reached can also be adjusted in this way. However, certain changes, e.g., age-related changes in the fuel injectors, have been shown to also have an effect on other or even all operating points. If such operating points are reached later, fuel can also be metered precisely there.

The correction map having the adjusted correction values is then provided for further use.

In one example embodiment of the present invention, the fields comprised by the one or the at least one of the plurality of field regions are adjusted as needed. For example, fields that have similar training values can be combined to make it simpler to adjust the correction values, especially since it can then be assumed that changes will also have an effect on these other fields. If it turns out that training values in fields do change again over time, the combination to form the field region can be adjusted again.

In one example embodiment of the present invention, adjusting a target quantity specified for metering fuel based on the correction values comprises determining an interpolated correction value, namely, based on at least two correction values (or fields) that are adjacent to the target quantity and the current pressure of the fuel in the high-pressure accumulator (i.e., the current operating point). The interpolated correction value is then used for the adjustment.

As mentioned above, there is one correction value per field, namely, in particular, exactly one correction value. If a field corresponds to a specific operating point with pressure and quantity, it can and will happen that a quantity to be metered has to be corrected at an operating point that does not exactly correspond to an operating point of the correction map. The (e.g., linear) interpolation thus allows for a particularly simple and precise correction; this is in particular simpler and more precise than if, for example, a plurality of correction values were provided for each field. In addition, this ensures a smooth transition between operating points.

In one example embodiment of the present invention, in order to determine a particular training value, it is provided that an estimated actual quantity is determined based on a target quantity specified for the metering of fuel, in particular using a machine learning model. An adjusted actual quantity is then determined based on the estimated actual quantity and the corresponding correction value. A deviation quantity is then determined based on the adjusted actual quantity and the target quantity. The deviation quantity is then adjusted based on at least one correction quantity, and the training value is determined based on the adjusted deviation quantity and a learning factor. The learning factor indicates, for example, a rate at which the correction factor is learned or adjusted. The smaller the learning factor, the smaller the training value based on a particular correction factor, and the smaller the adjustment of the correction factor.

It is also possible to extend the correlation maps and to divide the adjustment map (or the determination of the correction values) according to different fuel injectors or fuel injector characteristics. For example, a division into ballistic and non-ballistic ranges or into certain quantity levels can be made on the basis of the operating points (e.g., pilot quantity, partial load, high-load range).

With the procedure according to the present invention, it is thus also possible to learn and adjust correction values in other ranges in which the vehicle is operated. The drift or the need for correction due to causes (e.g., wear) typically occurs across the entire map range. This is not taken into account in previous concepts. It may also be that training values have been created but are now outdated because the range has not been used for a long time. In addition, some ranges are canceled by dominant ranges in current concepts. The virtual sensor used to detect the flow rate or flow quantity may have an inhomogeneous topology across the correction map. This has an additional tolerance contribution and a negative impact on the adjustment, which can be taken into account with the procedure according to the present invention.

A computing unit according to the present invention, e.g., a control unit of a motor vehicle, is configured, in particular programmatically, to carry out a method according to the present invention.

Furthermore, the implementation of a method according to the present invention in the form of a computer program or computer program product having program code for carrying out all the method steps of the present invention is advantageous because it is particularly low-cost, in particular if an executing control unit is also used for further tasks and is therefore present anyway. Finally, a machine-readable storage medium is provided with a computer program as described above stored thereon.

Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description herein and the figures.

The present invention is shown schematically in the figures on the basis of an exemplary embodiment and is described below with reference to the figures.

### BRIEF DESCRIPTION OF THE DRAWINGS

FIG. 1 schematically shows an internal combustion engine with a common rail system which is suitable for carrying out a method according to the present invention.

FIGS. 2 and 3 schematically show a sequence of a method in one example embodiment of the present invention.

### DETAILED DESCRIPTION OF EXAMPLE EMBODIMENTS

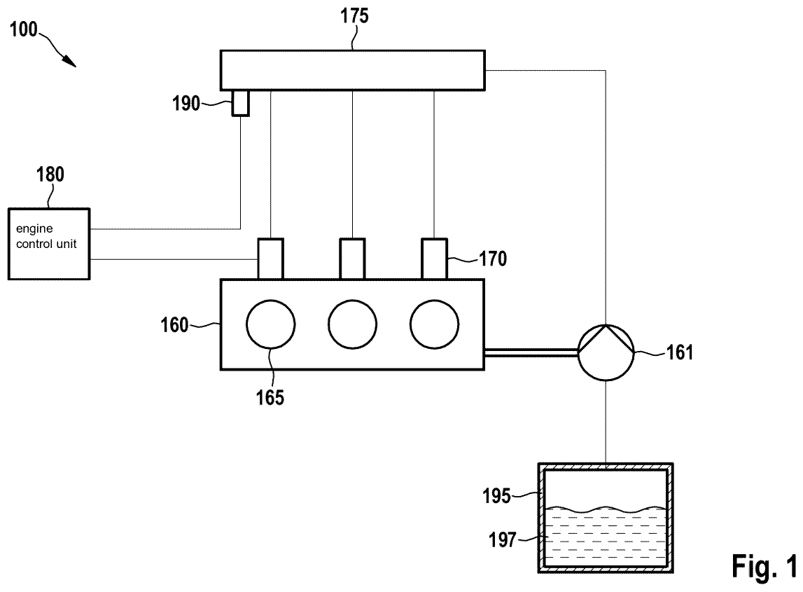

FIG. 1 schematically shows an arrangement 100 with an internal combustion engine 160, which is suitable for carrying out a method according to the present invention. For example, the internal combustion engine 160 comprises three combustion chambers or associated cylinders 165. Each combustion chamber 165 is assigned a fuel injector 170, which in turn is connected to a high-pressure accumulator 175, a so-called (common) rail, and via which it is supplied with fuel. It is understood that a method according to the present invention can also be carried out in the case of an internal combustion engine with any other number of cylinders, for example one, two, four, five, six, eight, ten, or twelve cylinders, etc.

Furthermore, the high-pressure accumulator 175 is fed with fuel 197 from a fuel tank 195 via a high-pressure pump 161. The high-pressure pump 161 is coupled to the internal combustion engine 160, namely, for example, in such a way that the high-pressure pump is driven via the internal combustion engine.

The fuel injectors 170 are controlled to meter or inject fuel into the respective combustion chambers 165 via a computing unit designed as an engine control unit 180. For the sake of clarity, only the connection from the engine control unit 180 to one fuel injector 170 is shown, but it is understood that each fuel injector 170 is correspondingly connected to the engine control unit. Each fuel injector 170 can be controlled specifically. Furthermore, the engine control unit 180 is configured, for example, to detect the fuel pressure in the high-pressure accumulator 175 by means of a pressure sensor 190.

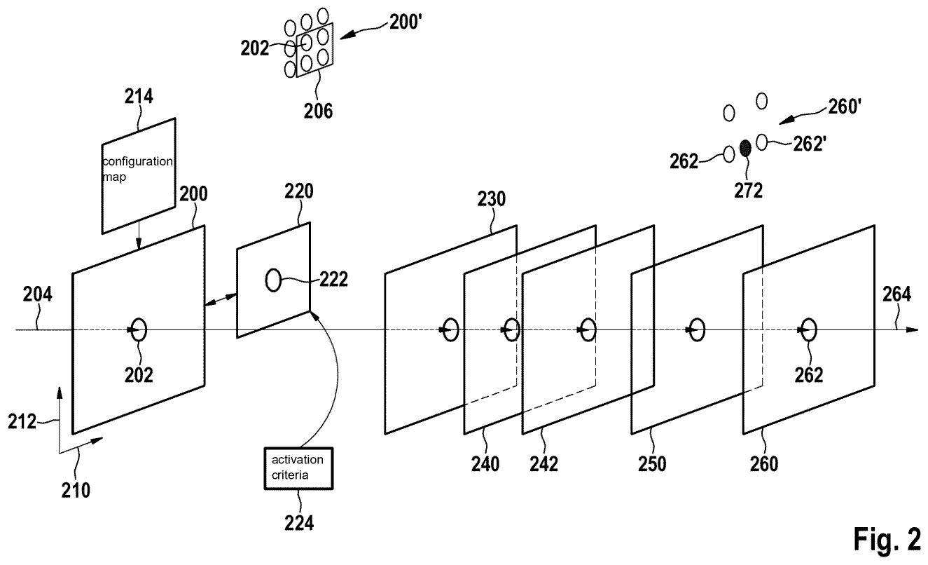

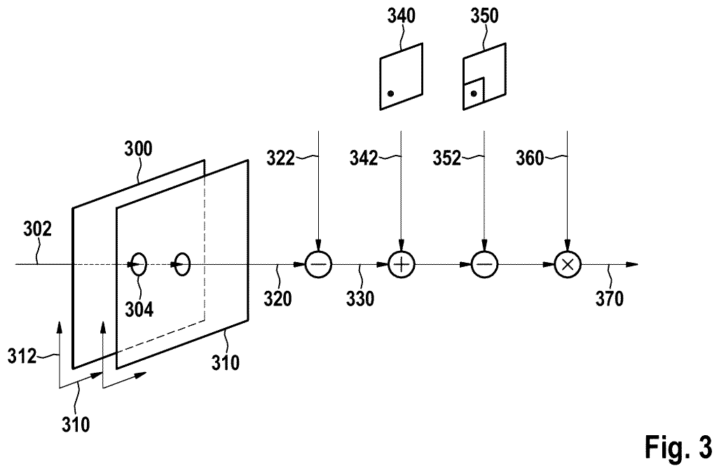

FIG. 2 shows a sequence of part of a method in one embodiment, namely, adjusting correction values based on training values. How training values can be obtained is shown in FIG. 3. Maps are in particular understood to be datasets that contain the corresponding data.

Shown here are a training map 200 and a correction map 260. The training map comprises a plurality of fields, wherein, by way of example, each of the plurality of fields is assigned a pressure of fuel in the high-pressure accumulator and a quantity of fuel to be metered. The pressure is plotted as axis 210 and the quantity is plotted as axis 212 next to the training map 200. By way of example, a field 202 is shown in the middle of the training map 200.

The training map 200 may, for example, comprise m x n fields, where m indicates the number of different pressures and n indicates the number of different quantities; this results in a matrix, wherein each field is assigned to an operating point with pressure and quantity.

The correction map 260 also comprises a plurality of fields, namely, corresponding to the training map. By way of example, a field 262 is shown in the middle of the correction map 260.

The training map may comprise one or more field regions, wherein the one or each of the plurality of field regions comprises one or more, in particular contiguous, fields of the plurality of fields. Each of the plurality of fields is assigned to a field region. It is possible that each field corresponds to a field region, but two or more fields can also be combined to form a field region. This can, for example, be adjusted if necessary. In this respect, a configuration map 214 is shown by way of example, based on which the training map or the field regions thereof can be adjusted. By way of example, nine fields (as a part 200′ of the training map 200), including the field 202, are shown to the right above the training map 200, with four of the fields being combined to form a field region 206, i.e., the field region 206 comprises four fields.

The training map 200 can be configured once using the configuration map 214. For a specific engine project, this configuration will generally not change throughout the service life.

An engine characteristic map can have regions that have the same need for correction. These regions or the corresponding fields in the training map can then be combined to form a field region. Both maps 214 and 220 can have the same size for this purpose. Fields in the map 214 can also be configured with “0”; such fields are then excluded from learning; the corresponding fields in the training map are not used for learning, i.e., for example, are not set to active field. However, such fields can possibly be taken into account as active neighboring fields or in another way with correlation rules. However, it is also possible that such fields are generally not taken into account, i.e., not even in the correction map.

In the training map 200, each of the plurality of fields 202 is assigned a training value, here denoted by 204 by way of example. In addition, in the training map 200, each field is assigned a status, here denoted by 222 in a status list 220 by way of example. The status of each field is a status from the status list 220, wherein the status list comprises the following statuses: active field, active neighboring field, inactive field, inactive field in a field region. In the correction map 260, each of the plurality of fields 262 is assigned a correction value, here denoted by 264 by way of example. In addition, there may be other statuses, namely, those used to determine the transfer values for inactive fields. This may vary, for example, depending on whether you move to the left, right, up or down (in the map) proceeding from a field region with an active field. In addition, as stated above, it is possible for one or more fields not to be taken into account or for fields to be deactivated but be taken into account for a transfer value.

In the correction map, the correction values are now adjusted based on the training values of the training map. The correction map having the adjusted correction values is then provided for further use.

The statuses of the fields in the training map 200 can change or be changed. If one or one of a plurality of specified activation criteria 224 is present, the status of a field is, for example, changed to active field; this may be the case, for example, if a number of learning events is higher than a specified threshold 14 Substitute Specification value. The status of active neighboring field then applies to fields adjacent to the field region that comprises an active field. That is to say, if, for example, (only) the field 202 is or becomes an active field, the fields of the part 200′ that lie outside the field region 206 are active neighboring fields, for example. The fields of the part 200′ that lie within the field region 206, except the active field 202, can then be inactive fields in the field region. All other fields (not shown here) can be inactive fields.

If the correction values in the correction map 260 are now adjusted, the training values of the training map 200 can be used. For this purpose, the training values, if necessary with adjustment, can first be transferred into an adjustment map 250 (which has the plurality of fields corresponding to the training map and correction map). For each field, the adjustment map 250 then contains a (possibly adjusted) training value, based on which the correction value in the corresponding field of the correction map 260 is adjusted.

For this purpose, a mean neighboring field training value can be generated in each of the active neighboring fields in the adjustment map 250. The mean neighboring field training value is determined based on the training values of the plurality of active neighboring fields. In other words, training values of the training map 200 are averaged in the active neighboring fields, and this mean value is entered into each active neighboring field in the adjustment map 250.

In each field of each field region that comprises an active field, i.e., for example, in each of the four fields of the field region 206, a mean field training value is generated in the adjustment map 250. The mean field training value is determined based on the training values of the active fields in the field region, i.e., in this case, it corresponds to the training value 202, for example. In the specific example, the training value 202 is thus entered into each field of the field region 206 in the adjustment map 250.

This transfer of training values with, if necessary, averaging for field regions with active fields as well as active neighboring fields can be carried out, for example, based on an averaging adjustment map 230.

In each inactive field, a transfer training value is generated in the adjustment map 230 or in the adjustment map 250. The transfer training value is, for example, determined with a correlation rule 240 and a correlation rule 242, in each case based on the training values of the active neighboring fields.

The correlation rule 240 may apply to new parts, while the correlation rule 242 may apply to parts that have reached the end of their service life.

For example, a factor can be assigned to all or only some fields via the correlation rule(s). If, starting from a field (starting field) for which an (adjusted) training value is present (this can be a neighboring field or an inactive field for which a transfer training value already exists), a transfer value is to be determined for an adjacent field (at least if a factor is present there), this can be done on the basis of the factors of the two fields concerned and the (adjusted) training value or transfer value of the starting field, e.g., using a quotient of the two factors. If the factor in the adjacent field is smaller than in the starting field, the transfer value there will become smaller and vice versa.

If there are two correlation rules (new parts and end of service life), each specifying different factors for the fields, interpolation can be carried out between these two correlation rules. Such an interpolation can be carried out, for example, depending on the number of training values, the mileage, the operating hours of the internal combustion engine or in another way.

Based on the (adjusted) training values thus generated in the adjustment map 250, the correction values can then be adjusted. In particular, even if only one training value is active in the training map, all correction values of the correction map are thus adjusted. It is also possible that the (adjusted) training values generated in the adjustment map 250 are used directly as correction values. In this case, the adjustment map 250 can be used as a correction map, or the generated (adjusted) training values are generated not in a separate adjustment map 250, but directly in the correction map.

This process of adjusting the correction values can be carried out repeatedly at regular intervals, for example, or depending on the route driven by the vehicle in question, or based on other criteria. For example, each time one or one of the plurality of activation criteria is present, a process of adjusting the correction values can be carried out. This can then, for example, be accompanied by changing a field to active, unless the relevant field is already active. It is also possible that this occurs at specified time intervals, defined for example on the engine control unit, of 100 ms, for example.

An interpolated correction value can then be used, for example, to adjust a target quantity specified for metering fuel based on the correction values. In the part 260′ of the correction map, four correction values are shown by way of example, each of which is assigned to a pressure and a quantity. However, if the target quantity does not correspond to any quantity of the correction values, but lies, for example, between the correction value 262 and the adjacent correction value 262′, the interpolated correction value 272 can be determined based on the correction values 262 and 262′. Such an interpolation between two correction values can be carried out linearly, for example. This relates to adjacent correction values or fields. Even if the current pressure does not correspond to one of the correction values, an interpolation can be carried out between two other or even three or four correction values. Here, it can be attempted, for example, to interpolate between three or four points.

FIG. 3 shows how training values can be obtained, such as those used in the training map 200 according to FIG. 2. For this purpose, actual quantities of a target quantity of fuel to be metered at a current pressure in the high-pressure accumulator can be estimated for different operating points. These estimated actual quantities can be entered, for example, into each of two adjustment maps, a global adjustment map 300 and a local adjustment map 310.

These operating points can be divided according to the plurality of fields of the training map and the correction map (cf. FIG. 2). In the adjustment map 300, one operating point is denoted by 304 by way of example. By way of example, each of the operating points is assigned to a pressure of fuel in the high-pressure accumulator and to a quantity of fuel to be metered. The pressure is plotted as axis 310 and the quantity is plotted as axis 312 next to the adjustment map 300. The same applies to the adjustment map 310.

The global adjustment map 300 and the local adjustment map 310 differ, for example, in their resolution. The global adjustment map 300 may thus comprise more fields than the local adjustment map 310. In this way, inhomogeneities (i.e., for example, missing information for certain fields) of the virtual sensor can be taken into account by first using the global adjustment map to correct errors. Remaining fields can then be corrected by means of the local adjustment map. The required data can be set once and remain constant throughout the service life.

Here, an estimated actual quantity 302 is now determined for the operating point 304 or ultimately for each operating point. As mentioned, this is done, for example, using a machine learning model or a virtual sensor. This estimated actual quantity 302 can be referred to as Qₛₑₙₛₒᵣ=ƒ(Q_{des}, Pᵣₐᵢₗ) and is therefore a function of the target quantity Q_{des} (axis 312) and the pressure in the high-pressure accumulator Pᵣₐᵢₗ (axis 310).

Using the adjustment maps 300, 310, the estimated actual quantity 302 is used to determine a corrected or adjusted actual quantity 320 or Qₛₑₙₛₒᵣ_{_{_}}_{adjusted}; in particular, this is thus used to correct errors of the virtual sensor. The target quantity Q_{des} or 322 is then deducted therefrom in order to obtain a deviation quantity Q_{deviation}=Q_{des}−Q_{sensor adjusted}, here denoted by 330.

The deviation quantity 330 or Q_{deviation} is then corrected additively with a first correction quantity 342 from, for example, a first correction quantity map 340 and subtractively with a second correction quantity 352 from, for example, a second correction quantity map 350. Both the first correction quantity and the second correction quantity can depend on the operating point (this can be done via the corresponding correction quantity map).

The first correction quantity can be used, for example, to take into account that the current operating point does not exactly correspond to the center point in the relevant field for which the correction value is present; here, an interpolation in the direction of the adjacent field can be carried out. The second correction quantity can be used, for example, to take into account the value of the correction value of the field in which the operating point is located, at the beginning (or before).

The deviation quantity adjusted in this way is then multiplied by a learning factor 360 so that the training value 370 (for the particular operating point) is obtained. The learning factor therefore ultimately indicates how strongly or how quickly the correction value is later corrected with the training value obtained (as explained with reference to FIG. 2). The learning factor is determined, for example, depending on the noise of the virtual sensor. The stronger the noise, the smaller the learning factor can be chosen (e.g., between 0 and 1).

1-11. (canceled)

12. A method for adjusting correction values for use in metering fuel using at least one fuel injector, from a high-pressure accumulator into a combustion chamber of an internal combustion engine, using a training dataset and a correction dataset, wherein the training dataset and the correction dataset each include a mutually corresponding plurality of fields, wherein each of the plurality of fields is assigned to a pressure or a pressure range of fuel in the high-pressure accumulator and to a quantity or a quantity range of fuel to be metered, wherein the training dataset includes one or more field regions, wherein the one or more field regions includes one or morer contiguous fields of the plurality of fields, wherein each of the plurality of fields is assigned to a field region, and wherein, in the training dataset, a training value and a status are assigned to each of the plurality of fields, wherein, in the correction dataset, a correction value is assigned to each of the plurality of fields, wherein the status of each of the plurality of fields of the training dataset is a status from a status list, wherein the status list includes at least the following statuses: active field, active neighboring field, inactive field, and wherein in the method comprises the following steps:
in the correction dataset, adjusting the correction values based on the training values of the training dataset, wherein the correction value in each of the active neighboring fields is adjusted based on a mean neighboring field training value, wherein the mean neighboring field training value is or has been determined based on the training value of the one or the training values of the plurality of active neighboring fields, wherein the correction value in each field of each field region that includes an active field is adjusted based on a mean field training value, wherein the mean field training value is or has been determined based on the training values of the active fields of the field region, and wherein the correction value in each inactive field is adjusted based on a transfer training value, wherein the transfer training value is or has been determined according to at least one correlation rule, based on the training values of the active neighboring fields; and
providing the correction map having the adjusted correction values for further use.

13. The method according to claim 12, wherein, wherein one or one of a plurality of specified activation criteria is present, the status of a field is changed to active field, and wherein the status of active neighboring field applies to fields adjacent to the field region that comprises an active field.

14. The method according to claim 13, wherein the one or the plurality of specified activation criteria are at least one of the following criteria:
a number of learning events is higher than a specified threshold value,
a number of learning events for an individual field is higher than a specified threshold value, and
a period of time or driving distance for an individual field in relation to a comparison time point or a comparison distance is greater than a specified threshold value.

15. The method according to claim 12, wherein, when one or one of a plurality of specified deactivation criteria is present, the status of a field is changed to inactive field.

16. The method according to claim 12, wherein the at least one correlation rule comprises one or more of the following rules:
a correlation rule applicable to new parts,
a correlation rule applicable to parts that have reached the end of their service life.

17. The method according to claim 12, further comprising, for determining each training value:
determining an estimated actual quantity, based on a target quantity specified for the metering of fuel, using a machine learning model,
determining an adjusted actual quantity, based on the estimated actual quantity and the corresponding correction value,
determining a deviation quantity, based on the adjusted actual quantity and the target quantity,
adjusting the deviation quantity, based on at least one correction quantity, and
determining the training value, based on the adjusted deviation quantity and a learning factor.

18. The method according to claim 12, wherein the fields included in the one or more of the plurality of field regions are adjusted as needed.

19. The method according to claim 12, wherein each of the plurality of fields is assigned to a pressure of fuel in the high-pressure accumulator and to a quantity of fuel to be metered, and wherein an adjustment of a target quantity specified for the metering of fuel based on the correction values includes:
determining an interpolated correction value, based on at least two correction values adjacent to the target quantity and a current pressure of the fuel in the high-pressure accumulator, wherein the interpolated correction value is used for the adjustment.

20. A computing unit configured to adjust correction values for use in metering fuel using at least one fuel injector, from a high-pressure accumulator into a combustion chamber of an internal combustion engine, using a training dataset and a correction dataset, wherein the training dataset and the correction dataset each include a mutually corresponding plurality of fields, wherein each of the plurality of fields is assigned to a pressure or a pressure range of fuel in the high-pressure accumulator and to a quantity or a quantity range of fuel to be metered, wherein the training dataset includes one or more field regions, wherein the one or more field regions includes one or morer contiguous fields of the plurality of fields, wherein each of the plurality of fields is assigned to a field region, and wherein, in the training dataset, a training value and a status are assigned to each of the plurality of fields, wherein, in the correction dataset, a correction value is assigned to each of the plurality of fields, wherein the status of each of the plurality of fields of the training dataset is a status from a status list, wherein the status list includes at least the following statuses: active field, active neighboring field, inactive field, and wherein the computing unit is configured to perform the following steps:
in the correction dataset, adjusting the correction values based on the training values of the training dataset, wherein the correction value in each of the active neighboring fields is adjusted based on a mean neighboring field training value, wherein the mean neighboring field training value is or has been determined based on the training value of the one or the training values of the plurality of active neighboring fields, wherein the correction value in each field of each field region that includes an active field is adjusted based on a mean field training value, wherein the mean field training value is or has been determined based on the training values of the active fields of the field region, and wherein the correction value in each inactive field is adjusted based on a transfer training value, wherein the transfer training value is or has been determined according to at least one correlation rule, based on the training values of the active neighboring fields; and
providing the correction map having the adjusted correction values for further use.

21. A non-transitory machine-readable storage medium on which is stored a computer program for adjusting correction values for use in metering fuel using at least one fuel injector, from a high-pressure accumulator into a combustion chamber of an internal combustion engine, using a training dataset and a correction dataset, wherein the training dataset and the correction dataset each include a mutually corresponding plurality of fields, wherein each of the plurality of fields is assigned to a pressure or a pressure range of fuel in the high-pressure accumulator and to a quantity or a quantity range of fuel to be metered, wherein the training dataset includes one or more field regions, wherein the one or more field regions includes one or morer contiguous fields of the plurality of fields, wherein each of the plurality of fields is assigned to a field region, and wherein, in the training dataset, a training value and a status are assigned to each of the plurality of fields, wherein, in the correction dataset, a correction value is assigned to each of the plurality of fields, and wherein the status of each of the plurality of fields of the training dataset is a status from a status list, wherein the status list includes at least the following statuses: active field, active neighboring field, inactive field, and wherein the computer program, when executed by a computer, causing the computer to perform the following steps:
in the correction dataset, adjusting the correction values based on the training values of the training dataset, wherein the correction value in each of the active neighboring fields is adjusted based on a mean neighboring field training value, wherein the mean neighboring field training value is or has been determined based on the training value of the one or the training values of the plurality of active neighboring fields, wherein the correction value in each field of each field region that includes an active field is adjusted based on a mean field training value, wherein the mean field training value is or has been determined based on the training values of the active fields of the field region, and wherein the correction value in each inactive field is adjusted based on a transfer training value, wherein the transfer training value is or has been determined according to at least one correlation rule, based on the training values of the active neighboring fields; and
providing the correction map having the adjusted correction values for further use.
